(19) United States
(12) Patent Application Publication
(10) Pub. No.: US 2008/0295347 A1
(43) Pub. Date: Dec. 4, 2008

(54) Moisture resistant chalk line composition for use with chalk line devices

(76) Inventor: Eric Barkley Braham, Morgantown, WV (US)

Correspondence Address: Brian A. Nath, JD, 1329 Hunter Lane, Morgantown, WV, 26505, US

(21) Appl. No.: 11/809,524

(22) Filed: Jun. 1, 2007

(51) Int. Cl. B44D 3/38; C09D 13/00

(52) U.S. Cl. 33/414; 106/31.01

(57) ABSTRACT

The present invention is moisture resistant chalk line composition comprising an effective amount of calcium carbonate, an effective amount of one or more dyes, and an effective amount of one or more hydrophobes, said effective amount of calcium carbonate comprises at least about 50% by weight of the composition, said effective amount of one or more dyes is selected from a range of about 0% to about 49% by weight of the composition, and said effective amount of one or more hydrophobes does not exceed about 30% by weight of the composition. The chalk line composition is useful for repeatedly marking guide lines with the same chalk line device on wet surfaces or moist environments. Also claimed is a method for repeatedly forming guide lines on surfaces utilizing a moisture resistant chalk line composition with a snap line from a chalk line device.

### DRAWINGS

Not Applicable

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The present invention relates to chalk line devices used to mark guidelines, and more particularly pertains to a composition for allowing the use of a chalk line device in unfavorable moist conditions. Common chalk used in chalk line devices may become unusable after the chalk line has become moistened from use on wet surfaces or in moist environments. Even chalk in the prior art for marking wet surfaces may not prevent the chalk line itself from becoming moist and ineffective. This chalk line composition allows continued effective use of a chalk line device in the aforementioned unfavorable conditions.

### BRIEF SUMMARY OF THE INVENTION

The present invention is a moisture resistant chalk line composition for use in chalk line devices. The chalk line composition consists of:

an effective amount of calcium carbonate;

an effective amount of one or more dyes; and

an effective amount of one or more hydrophobes;

A hydrophobe shall be defined as a substance with the physical characteristics of repelling, tending not to combine with, or being incapable of dissolving in water. Hygroscopic shall be defined as readily taking up and retaining moisture.

An aspect of the present invention is that use of the chalk line composition allows the chalk line to remain usable and effective after repeated contact with wet surfaces moist environments.

A further aspect of the present invention is the ability to mix the moisture resistant composition with common chalk line compositions of varying color and intensity to obtain the desired marking result while adding greater functionality in moist and wet conditions.

Another aspect of the present invention is the addition of a water proof like element to the chalk line itself, creating a more rain and water resistant line mark.

Yet another aspect of the present invention is a method for repeatedly forming guide lines on surfaces utilizing a moisture resistant chalk line composition comprising mixing an effective amount of calcium carbonate, one or more dyes, and one or more hydrophobes to form a chalk line composition, applying said chalk line composition to a snap line from a chalk line device, stretching said snap line outwardly from said chalk line device adjacent a surface, snapping said snap line against said surface to form a guide line with said chalk line composition transferred from said snap line to said surface, and repeating this process.

### DETAILED DESCRIPTION OF THE INVENTION

The present invention contemplates an improved chalk line composition for use in chalk line devices resulting in greater utility for repeated use of the chalk line device in wet and moist conditions.

The combination of calcium carbonate, one or more dyes, and one or more hydrophobes can result in an effective composition. Effective amounts of calcium carbonate comprises at least about 50% by weight of the composition, effective amounts of one or more dyes are selected from a range of about 0% to about 49% by weight of the composition, and effective amounts of one or more hydrophobes does not exceed about 30% by weight of the composition. A hydrophobe is a substance with the physical characteristics of repelling, tending not to combine with, or being incapable of dissolving in water such as talc, celite, kaolin, red oxide, rice starch, bentonite, aluminum stearate, indium borate, indium hydroxide, desoxycorticosterone acetate, dehydrocholic acid, crospovidone, barium titanates, and aluminium powder. The use of over about 30% hydrophobe or hydrophobes by weight of the composition begins to reduce effectiveness of the resulting guide line as the line can wash away more easily due to the hydrophobic qualities of the composition. In addition, a user could add a hygroscopic substance, a substance readily taking up and retaining moisture, as long as the overall mixture remains hydrophobic in nature.

The chalk line composition in which the hydrophobe concentration does not exceed about 30% by weight has hydrophobic qualities which allow for the repeated use of a chalk line device in wet or moist environments without the snap line becoming ineffective in producing a guideline.

The chalk line composition can be white or further whitened or colored with various dyes such as iron oxide pigments and titanium dioxide. Additionally, the product may be mixed with common colored chalk line compositions to achieve desired colorations and permanence.

The preferred embodiment of the chalk line composition comprises using the combination of about 65-75% calcium carbonate by weight of the composition, about 0-20% iron oxide pigments by weight of the composition, about 0-20% titanium dioxide by weight of the composition, and less than about 20% of an inexpensive hydrophobe such as lycopodium by weight of the composition. An example of this embodiment is to use the combination manufactured under the trade name Antiqueing Release Agent by Specialty Concrete Products, Inc. of West Columbia, S.C.

The present invention also includes a method for repeatedly forming guide lines on surfaces utilizing a moisture resistant chalk line composition comprising mixing an effective amount of calcium carbonate, one or more dyes, and one or more hydrophobes to form a chalk line composition, applying said chalk line composition to a snap line from a chalk line device, stretching said snap line outwardly from said chalk line device adjacent a surface, snapping said snap line against said surface to form a guide line with said chalk line composition transferred from said snap line to said surface, and repeating.

What is claimed is:

1. A moisture resistant chalk line composition for applying to a snap line of a chalk line device, said chalk line composition comprising:
an effective amount of calcium carbonate;
an effective amount of one or more dyes; and
an effective amount of one or more hydrophobes.

2. The chalk line composition of claim 1 wherein said effective amount of calcium carbonate comprises at least about 50% by weight of the composition, wherein said effective amount of one or more dyes is selected from a range of about 0% to about 49% by weight of the composition, and wherein said effective amount of one or more hydrophobes does not exceed about 30% by weight of the composition.

3. The chalk line composition of claim 1 wherein said one or more dyes are chosen from iron oxide pigments and titanium dioxide.

4. The chalk line composition of claim 1 wherein at least one of said one or more hydrophobes are chosen from talc, celite, kaolin, red oxide, rice starch, bentonite, aluminum stearate, indium borate, indium hydroxide, desoxycorticosterone acetate, dehydrocholic acid, crospovidone, barium titanates, and aluminium powder.

5. The chalk line composition of claim 1 wherein at least one of said one or more hydrophobes is also hygroscopic.

6. The chalk line composition of claim 1 wherein said composition comprises a mixture wherein said mixture is manufactured under the trade name Antiqueing Release Agent by Specialty Concrete Products, Inc. of West Columbia, S.C.

7. A method for repeatedly forming guide lines on surfaces comprising the acts of:
mixing an effective amount of calcium carbonate, one or more dyes, and one or more hydrophobes to form a chalk line composition;
applying said chalk line composition to a snap line from a chalk line device;
stretching said snap line outwardly from said chalk line device adjacent a surface;
snapping said snap line against said surface to form a guide line with said chalk line composition transferred from said snap line to said surface; and
repeating.

8. The method of claim 6 wherein said effective amount of calcium carbonate comprises at least about 50% by weight of the composition, said effective amount of one or more dyes is selected from a range of about 0% to about 49% by weight of the composition, and said effective amount of one or more hydrophobes does not exceed about 30% by weight of the composition.
